(19) United States
(12) Patent Application Publication
(10) Pub. No.: US 2019/0070070 A1
(43) Pub. Date: Mar. 7, 2019

(54) SPA BATH WITH HEAT PUMP

(71) Applicant: Park Leisure Solutions Ltd., Exeter (GB)

(72) Inventor: Stuart MULCAHY, Poole (GB)

(21) Appl. No.: 16/119,417

(22) Filed: Aug. 31, 2018

(30) Foreign Application Priority Data
Sep. 1, 2017 (GB) 17 14 016.1

(51) Int. Cl. A61H 33/00

(52) U.S. Cl. CPC A61H 33/0095; A61H 2201/0242; A61H 2201/0207; A61H 33/60

(57) ABSTRACT

Water in a spa bath is heated by an air source heat pump installation 500 enclosed within a housing 502 and operable by way of a control system 520. A fan 504 draws ambient air A into the housing 502 through an air inlet 506 and thence through an evaporator 508. The air inlet 506 and the evaporator 508 each extend substantially from side to side and from top to bottom of the housing 502 and are balanced in relation to the flow or air A, being each formed with airways that in aggregate cross-sectional area are substantially the same. This reduces the drop in air pressure and hence the power required to drive the heat pump installation 500.

### CROSS REFERENCE TO RELATED APPLICATIONS

This application claims priority from United Kingdom Patent Application No. 17 14 016.1, filed 1 Sep. 2017.

### BACKGROUND OF THE INVENTION

This invention relates to a spa bath including a heat pump operable to heat water in the bath.

As used herein, the term “spa bath” refers to a facility including a tub of water, usually aerated and circulated, to accommodate one or more people for rest and recreation or possibly therapeutic purposes. It shall be deemed herein to include hot tubs, swimming pools, plunge pools and ice baths.

Particularly in temperate climate zones it is generally necessary to heat the water of a spa bath, and the present invention can be directed to that end, and also to heating water in a swimming pool. Otherwise, in a heatwave or in the tropics, or for cold-immersion therapy, users may require the water to be cooled, and the present invention can be adapted to meet that requirement as well.

The invention is particularly but not exclusively applicable to spa baths installed in substantial numbers in leisure parks or caravan sites where it is necessary for each resident to have individual control of the operation and cost (typically by rental) of an allocated spa bath. It may also be applied to spa baths for use in individual domestic properties.

Heaters for the water may be of various forms, including wood-fired or gas-fired heaters and solar collectors, but are mostly electrical, usually some kind of through-flow heater or some kind of heat pump. Cooling is usually done by refrigeration (essentially a heat pump run in reverse) although for cold immersion therapy ice may be physically added to the water.

Heat pumps are efficient but heretofore it has proved difficult to make them compact enough for heating water specifically for a spa bath. Household-scale installations are known from, for instance, Chinese Utility Models CN202008223, CN201787665 and CN2802345 and French Patent Application FR2382656. But a spa bath requires a much more compact installation, especially where this needs to be individually operated and controlled, as where multiple spa baths are installed in a leisure park. Compactness is also important for aesthetic reasons, as users of individual spa baths would likely be discomfited by large scale heating plant in the immediate vicinity.

### BRIEF SUMMARY OF THE INVENTION

According to the invention there is provided a heat pump installation including a heat pump operable by way of a control system to heat water for a spa bath, wherein the heat pump utilises a working fluid circulated on a fluid path including—

an evaporator for the working fluid;

a fan operative to pass ambient air through airways in the evaporator to transfer heat to and thereby evaporate the working fluid;

a compressor for the heated working fluid; and

a condenser for the heated and compressed working fluid configured and arranged to transfer heat from the working fluid to the water;

characterised in that:

the heat pump installation comprises a housing enclosing the heat pump and the control system and channelling the fanned air through the evaporator from an air inlet in the housing and

the evaporator and the air inlet each extend substantially from side to side and from top to bottom of the housing.

spa bath comprising a tub for water and a heat pump operable to heat water in the tub, which heat pump utilises a working fluid circulated on a fluid path including an evaporator for the working fluid in contact with ambient air and configured and arranged to extract heat from ambient air and a condenser for the working fluid in contact with the water and configured and arranged to deliver heat to the water, characterised in that the spa bath includes a control system operable to control temperature of water in the tub and the heat pump is contained within a housing comprising an inlet for the air and an outlet for the air.

The invention extends to a spa bath including the heat pump installation together with a tub for the water and a thermally insulative cabinet for the tub, characterised in that the heat pump installation is configured and arranged for installation within the cabinet and to use therein the ambient air as its source of heat.

### BRIEF DESCRIPTION OF THE SEVERAL VIEWS OF THE DRAWINGS

FIG. 1 illustrates the operation of a heat pump;

FIG. 2 illustrates a spa bath embodying a possible aspect of the present invention including a heat pump installation;

FIG. 3 illustrates a spa bath which may include the heat pump installation of FIG. 2;

FIG. 4 illustrates the heat pump installation of the spa bath shown in FIG. 2;

FIGS. 5 to 7 show an improved heat pump installation for a spa bath, respectively in front elevation, side elevation and rear elevation;

FIG. 8 is an isometric view showing the arrangement of the heat pump installation of FIGS. 5 to 7 within its casing;

FIG. 9 is a vertical cross-section through the ait inlet and the condenser of the heat pump installation of FIGS. 5 to 7, illustrating the flow of air therethrough;

FIG. 10 is a schematic representation of the control system of the heat pump installation of FIGS. 5 to 7; and

FIG. 11 shows the manual controller of the control system of FIG. 10.

### DETAILED DESCRIPTION OF EMBODIMENTS OF THE INVENTION

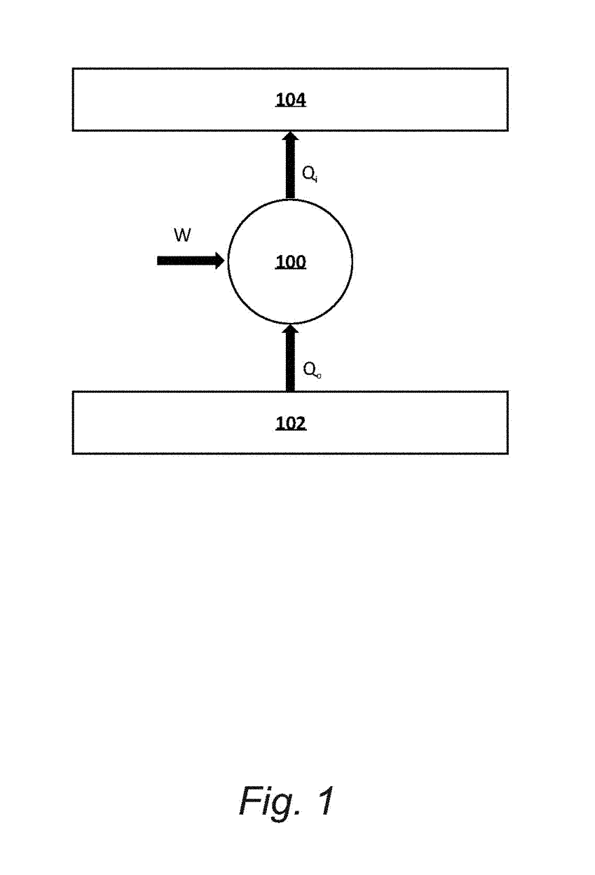

### FIG. 1

Referring first to FIG. 1, this shows a heat pump system 100 operative (by means which will be well understood by those skilled in the art) to extract heat Qo from a source 102 using a working fluid such as the hydrofluorocarbon R407C which is evaporated at the source 102. Thus the temperature of the source 102 is decreased and the temperature of the working fluid is increased. Then the working fluid is compressed—that is to say, work W is done on the system—and as a result the temperature of the working fluid is further increased. Next the working fluid is fed to the sink 104, delivering heat Qi to the sink 104. Thus the sink 104 is heated, and the working fluid id condensed back to a liquid state. And finally the condensed working fluid is recirculated back to the source 102 so that the cycle may continue.

The system of FIG. 1 may be used for heating or for cooling. In heating mode, the system extracts heat Qo from a source 102 such as air and delivers heat Qi (=Qo+W) to the sink 104 with the purpose of heating it. In this way a heat pump installation may be used to heat water in a spa bath, its efficiency being measured by the coefficient of performance (Qo+W)/W. The coefficient of performance is greater than 1, meaning that a heat pump is necessarily more efficient than a straightforward electric heater.

In cooling mode, the system extracts heat Qo from a source 102 such as water and discharges it to a sink 104 such as the surrounding air. In this way a heat pump installation may be used to cool water in a spa bath, its efficiency being measured by the coefficient of performance Qo/W.

It follows that a heat pump installation associated with a spa bath may be used to heat water in the tub, which will be the commonest mode of operation in temperate climate zone, or it may effectively be run in reverse to cool the water in the tub. Hereinafter, however, it is considered sufficient to describe a system in heating mode, as those skilled in the art will be readily able to envisage its operation in cooling mode.

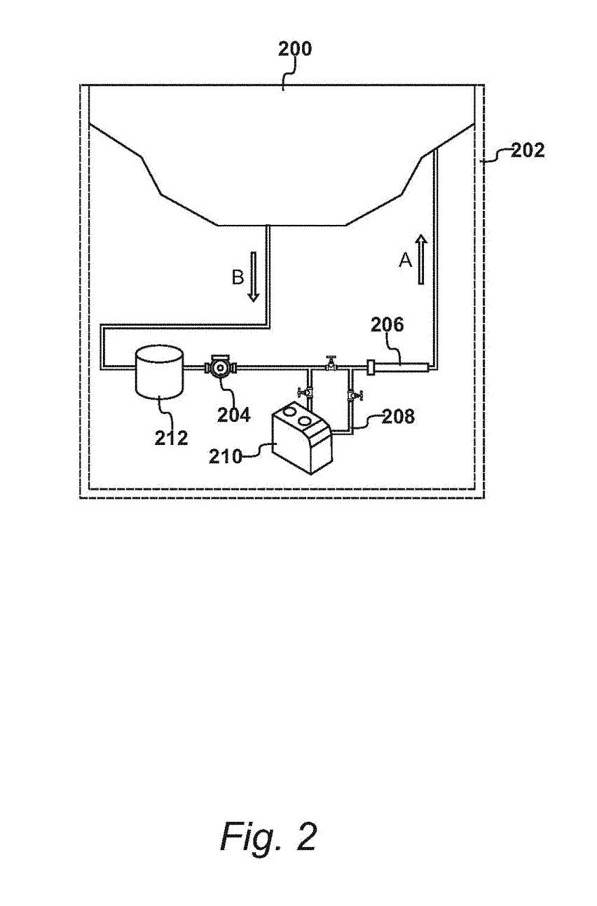

### FIG. 2

Referring to FIG. 2 this illustrates a spa bath comprising a tub 200 seated in and supported by a thermally insulative cabinet 202 indicated in broken lines.

A heat pump installation within the cabinet is used to heat water in the tub 202. A water pump 204 pumps water around a circuit including the tub 200, as indicated by the arrows A and B. The circuit includes a through-flow electric heater 206 operable to heat the water fed to the tub 200 at A. Also connected to the circuit, on a branch 208 thereof that may be shut off, is a heat pump 210 which also heats the water fed to the tub at A. The hot water at A is fed into and across the tub and thereafter exits at B and passes through a filter 212 and thence around the circuit again.

The heat pump 210 is an air source heat pump working within the cabinet 202 to draw heat from ambient air.

The presence of the electric heater 206 should not be taken as an indication that the heat pump 210 may not be able to heat the water adequately. Rather, the electric heater has an important ancillary function. Holiday complexes such as leisure parks are commonly provided with large numbers of spa baths associated with cabins, caravans or the like rented by holidaymakers, typically on a weekly basis with a specified changeover day. On changeover day it is necessary among other things to drain each spa bath, clean it, refill it with water and bring the water up to operating temperature before the new occupants arrive. This last task is especially challenging because it requires a minimum amount of time, and the electric heater 206 ensures that it can be met. (In practice, of course, the operators of a holiday park know quite precisely how long a newly filled tub 200 will take to heat up, and schedule the work accordingly). Once the water is up to operating temperature, the electric heater 206 can be switched off (eg under the control of a thermostat) and the temperature can be maintained by the heat pump 210. Thus the invention provides economical heating during normal operation and fast heating during changeover periods.

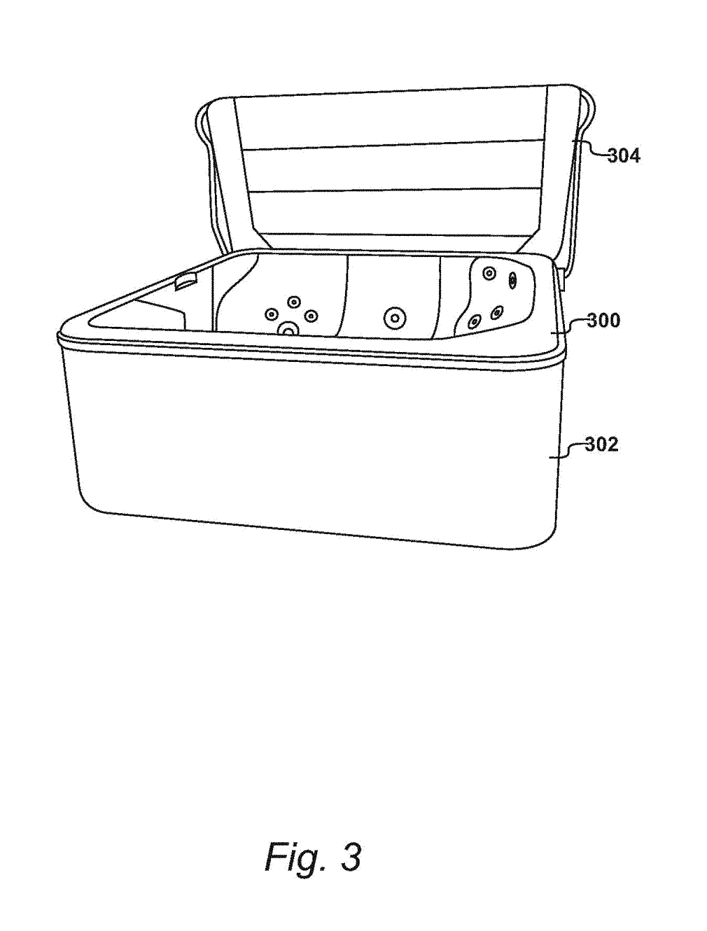

### FIG. 3

FIG. 3 shows a spa bath comprising a tub 300 for water seated in and supported by a thermally insulative cabinet 302. The cabinet 302, which has a lid 304 (shown raised in FIG. 3) for retaining heat in the water when the spa bath is not in use, is not much deeper than the tub 300. Comparing FIG. 3 with FIG. 2, it should be understood that FIG. 2 exaggerates the depth of the cabinet 202, for clarity of illustration. In practice the relative depths of the tub 200 and the cabinet 202 will be similar to those depicted in FIG. 3.

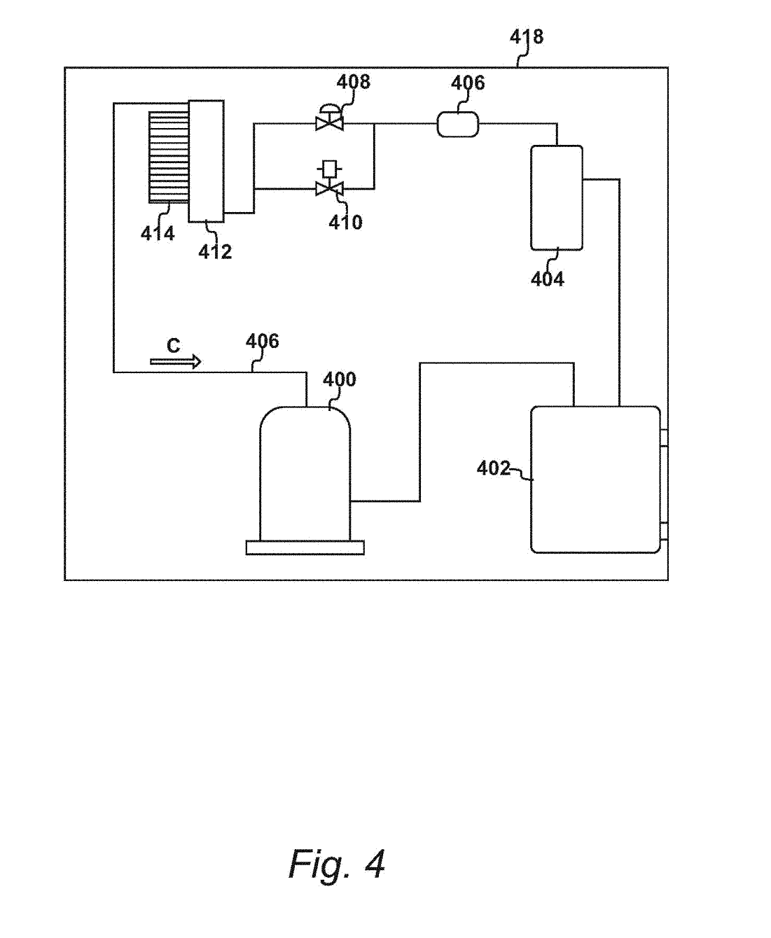

### FIG. 4

The heat pump installation of a spa bath according to the present invention comprises utilizes air:water heat pump technology and comprises, referring to FIG. 4, a compressor 400, a tubular condenser 402, a heat pump system 404, a drier filter 406, an expansion valve 408, a selectively operable solenoid valve 410, an overpressure centrifugal fan 412 and a finned coil heat exchanger 414, all interconnected by a circuit 416 around which working fluid flows as indicated by the arrow C and contained within a housing 418 formed with inlets and outlets for air and water.

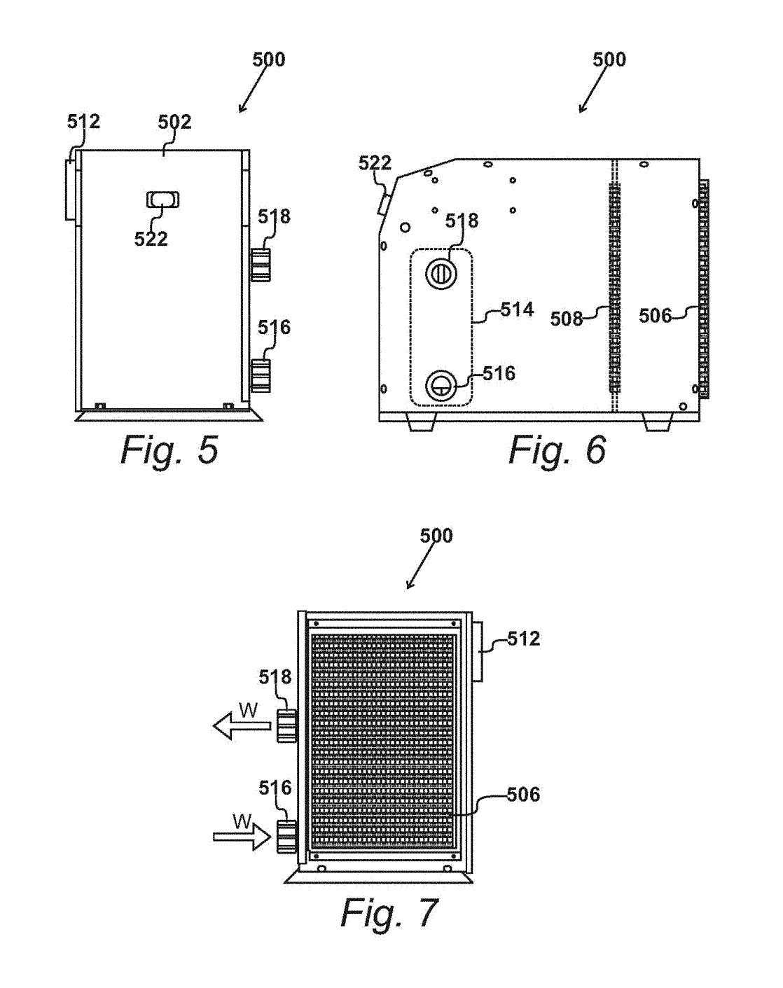

### FIGS. 5 to 8

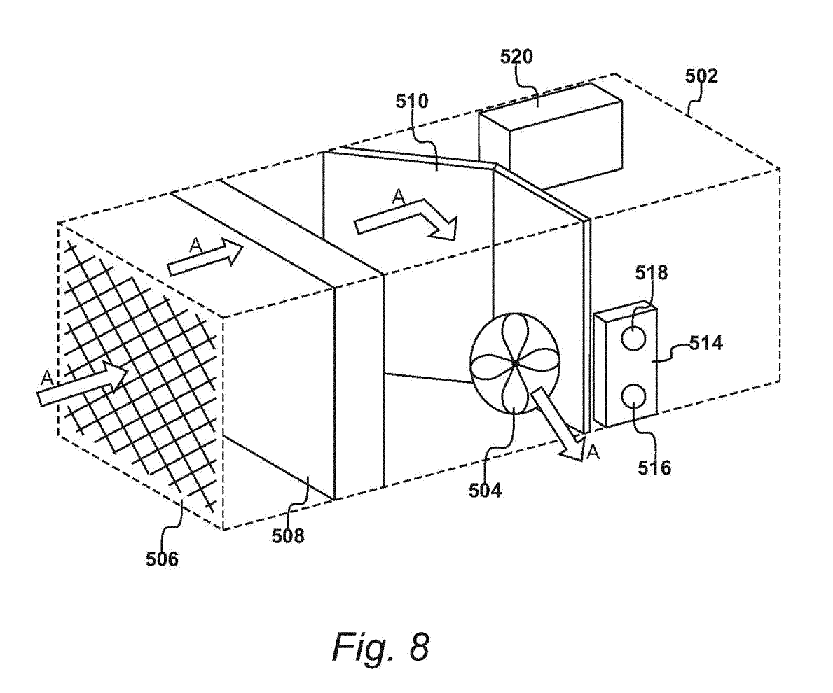

FIGS. 5 to 8 show an improved heat pump installation 500 for a spa bath like that of FIGS. 2 to 4. FIG. 5 shows the heat pump installation 500 in front elevation, FIG. 6 in side elevation and FIG. 7 in rear elevation, and FIG. 8 is an isometric view showing the arrangement of the heat pump illustration 500 within its casing 502.

A fan 504 (FIG. 8) at one side of the casing 502 draws ambient air A endways into the casing 502 through an air inlet 506 at the rear end of the casing 502. The air inlet 506 extends substantially wholly across the rear end of the housing 502, from side to side and from top to bottom, and this maximised cross-section of the air inlet 506 allows the greatest possible amount of air A to be drawn in with minimised restriction so that the power required is reduced. The fanned air A drawn through the air inlet 506 passes through the evaporator 508 of the heat pump installation 500 and is then turned by an air diverter 510 extending obliquely across the casing 502 to exit sideways though an air outlet 512 surrounding the fan 504.

The working fluid of the heat pump installation 500 is pumped through the evaporator 508 and therein heated in the way described hereinbefore, which will be readily understood by those familiar with heat pumps. Like the air inlet 502, the evaporator 506 extends substantially wholly across the housing 502, from side to side and from top to bottom, also reducing restriction on the flow of the air A and reducing the power required to drive it. The working fluid heated in the evaporator 506 is compressed and passed to a heat exchanger 514 which transfers heat to water for the tub (not shown in FIGS. 5 to 8) of a spa bath, receiving the water W from the tub through a water inlet 516 in the side of the casing and returning it to the tub by way of a water outlet 518.

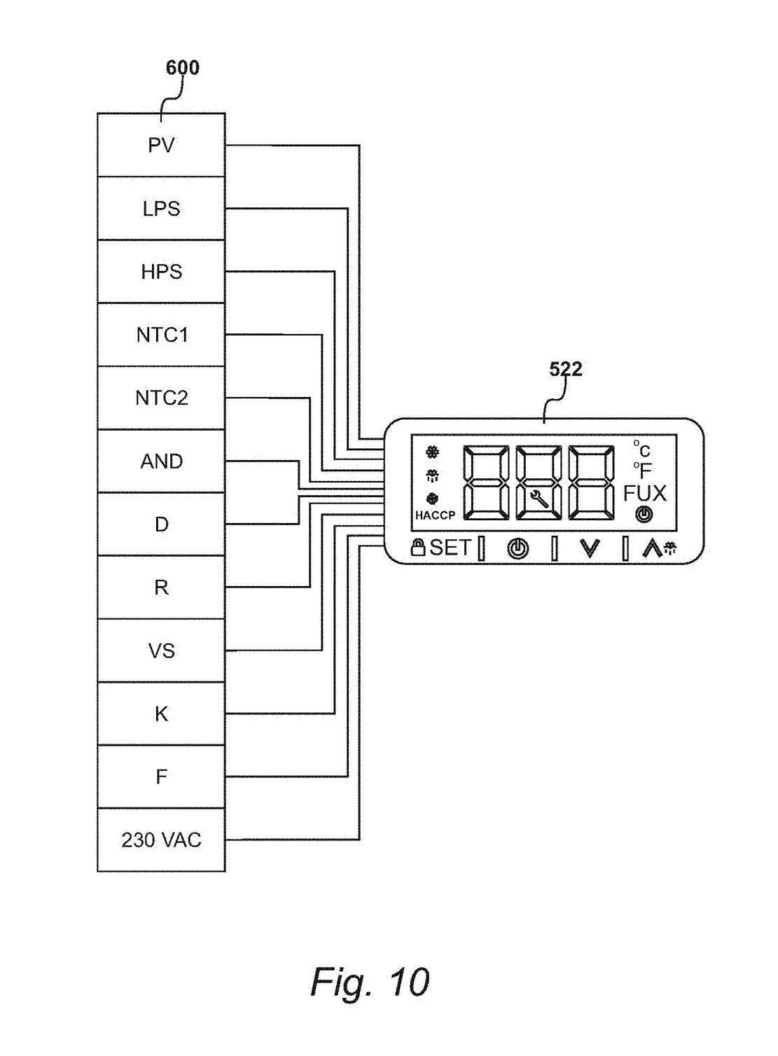

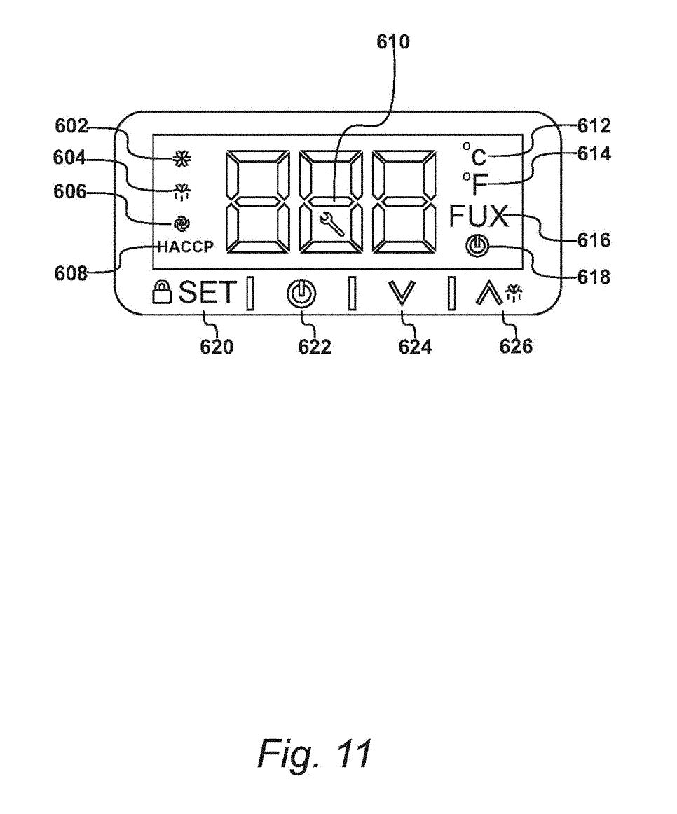

The heat pump installation 500 includes an electrical control system 520 (FIG. 8) manually adjustable by means of a control pad and display 522 on the front of the housing 502. The operation of the control system 520 will be described in more detail hereinafter with reference to FIGS. 10 and 11.

Other features of the heat pump installation can be discerned from FIG. 8. For electrical safety, the control system 520 is located within the housing 502 (ghosted in FIG. 8) remote from the air inlet 506 (which could admit rain or other moisture entrained with the indrawn air) and the heat exchanger 514 with its water connections 516 and 518. In addition, with regard to the air inlet 506, the control system 520 is behind the air diverter 510, which prevents possibly moist air reaching the control system 520. Further, the housing 502 is constructed to resist the penetration of rain or other atmospheric moisture. This combination of features gives the heat pump installation 500 a high degree of ingress protection (IP).

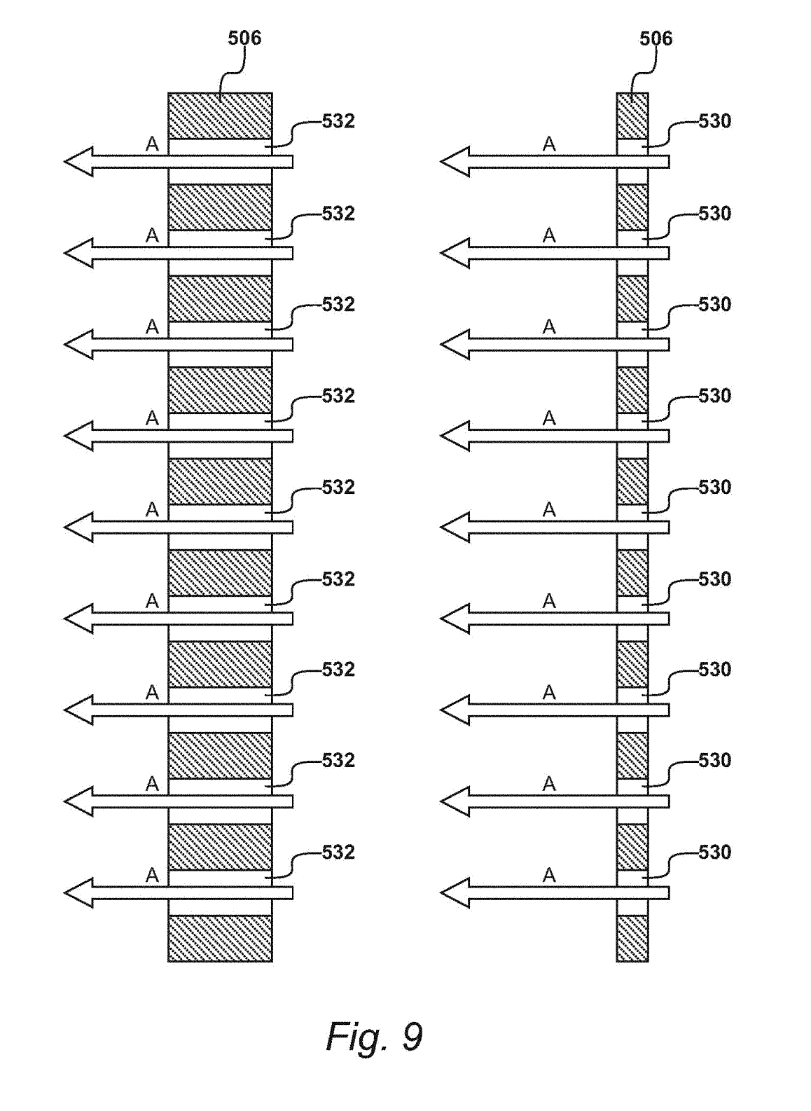

### FIG. 9

A particularly significant feature of the heat pump installation 500 will now be described with reference to FIG. 9. The fanned air A passes through airways 530 in the air inlet 506 and thereafter through airways 532 in the evaporator 508. The aggregate cross-sectional area (that is, orthogonal to the air flow A) of the airways 530 through the air inlet 506 is substantially equal to the aggregate cross-sectional area of the airways 532. This provides a balanced or “equilibrated” air flow through the evaporator 508, reducing the drop in pressure of the air and generally increasing the volume of the air flow A. Thus the electrical power required to drive the heat pump installation 500 is reduced.

Measurements on the heat pump installation 500 show a pressure drop of not more than 100 Pa. At an ambient air temperature of 15° C. the measured heating capacity is 7.787 kW for an input of only 1.568 kW—a Coefficient of Performance close to 5. And even with an ambient air temperature as low as 7° C. an input of 1.580 kW produces a heating capacity of 6.343 kW (CoP˜4). The heat pump installation 500 can efficiently deliver a water temperature of 35° C. down to low ambient temperatures.

For the avoidance of uncertainty, it should be noted that in FIG. 9 the airways 530 and the airways 532 are shown as being the same in number and transverse dimension purely for simplicity of illustration. In practice they are most likely to differ in both number and transverse dimension, inasmuch as the air inlet 506 will usually be some form of foraminated plate whereas the evaporator is likely to be a casting with its airways cast in it.

### FIG. 10

FIG. 10 is a schematic illustration of the control system 520 (FIG. 8) comprising a terminal block 600 operatively connected to the control pad and display 522 (FIGS. 5 and 6).

The terminals of the terminal block 600 as labelled in FIG. 10 are as follows.

PV Photovoltaic connection (for optional solar power addition)

LPS Low pressure switch

HPS High pressure switch

NTC1 Water temperature probe

NTC2 Ambient temperature probe

D Display

R Electrical resistance

VS Solenoid valve

K Compressor

F Fan

230 VAC Power supply

### FIG. 11

FIG. 11 is an enlarged view of the keypad and display 522, which is used to control and monitor the heat pump installation and as well as a digital display shows the following symbols: compressor working 602, defrost active 604, fan working 606, alarm active 608, compressor hours exceeded 610, reading in Celsius 612, reading in Fahrenheit 614, electric heater on 616 and standby 618.

The keypad of the keypad and display 522 carries manually operable keys Set/Confirm 620, ON/Standby 622, Down arrow 624 and Up arrow 626.

The heat pump installation 500 is configured and arranged to be operated as follows. When the heat pump installation 500 has been connected to its power supply, the standby symbol 618 is illuminated. Then, pressing the ON/Standby key for 4 s activates the heat pump installation 500, and the water temperature is shown by the digital display. To adjust the water temperature: the Set/Confirm key 620 is pressed once, and SP 1 appears on the digital display; the Set/Confirm key is pressed again, and the current water temperature appears on the digital display; the Up arrow 626 or Down arrow 624 can then be pressed to select a new water temperature (maximum 35° C.); pressing the Set/Confirm key 620 once more now sets the selected water temperature, and the heat pump installation 500 automatically adjusts the water temperature accordingly.

Because of its coefficient of performance, a heat pump installation embodying the present invention is environmentally friendly. It can be readily incorporated in both new and existing spa baths, connected with new or existing thermostats and heating elements, and operated jointly or individually as required by a user.

The invention claimed is:

1. A heat pump installation including a heat pump operable by way of a control system to heat water for a spa bath, wherein the heat pump utilises a working fluid circulated on a fluid path including—
an evaporator for the working fluid;
a fan operative to pass ambient air through airways in the evaporator to transfer heat to and thereby evaporate the working fluid;
a compressor for the heated working fluid; and
a condenser for the heated and compressed working fluid configured and arranged to transfer heat from the working fluid to the water;
wherein the heat pump installation comprises a housing enclosing the heat pump and the control system and channelling the fanned air through the evaporator from an air inlet in the housing,
and wherein the evaporator and the air inlet each extend substantially from side to side and from top to bottom of the housing.

2. A heat pump installation as claimed in claim 1 wherein the air inlet is formed with airways for the air which in aggregate cross-sectional area are substantially equal to the aggregate cross-sectional area of the airways in the evaporator.

3. A heat pump installation as claimed in claim 2 wherein the air inlet is formed in an end of the housing and the housing is formed in one side with an outlet for the fanned air.

4. A heat pump installation as claimed in claim 3 wherein the fan is located in the air outlet to draw air through the air inlet and the evaporator by suction.

5. A heat pump installation as claimed in claim 3 wherein an air diverter extends obliquely across the housing to directed the fanned air from the endways inlet to the sideways outlet.

6. A heat pump installation as claimed in claim 2 including a water pump for the water and wherein the housing is formed with an inlet and an outlet for the pumped water each connected to the condenser, the water outlet delivering heated water and the water inlet returning water for reheating.

7. A heat pump installation as claimed in claim 2 wherein the control system is located within the housing remote from the air inlet and from the water inlet and the water outlet.

8. A spa bath comprising a tub for the water, a thermally insulative cabinet for the tub and a heat pump installation as claimed in claim 2 operable to heat the water, wherein the heat pump installation is configured and arranged for installation within the cabinet and to use therein the ambient air as its source of heat.

9. A spa bath as claimed in claim 8 wherein the working fluid is pumped around a fluid path including a thermal expansion valve operative to control the amount of working fluid passing through the evaporator.

10. A spa bath as claimed in claim 9 characterised in that the heat pump is located in a branch of the fluid path including a shut-off valve selectively operable.

11. A bath as claimed in claim 9 wherein the fluid path includes a drier-filter for the working fluid.

12. A spa bath as claimed in claim 8 wherein the spa bath includes a water pump operable to pump water in and through the tub and the condenser.

13. A spa bath as claimed in claim 12 wherein the spa bath includes an air pump operable to pump air into the water in the tub.

14. A spa bath as claimed in claim 8 wherein the spa bath includes a thermostat operatively connected to the heat pump installation and adjustable to vary the temperature of water in the tub.

15. A spa bath as claimed in as claimed in claim 8 wherein the spa bath includes an electric heater operable in addition to the heat pump installation to heat the water.
